(19) United States
(12) Patent Application Publication
(10) Pub. No.: US 2024/0412144 A1
(43) Pub. Date: Dec. 12, 2024

(54) COMPUTER SYSTEM AND SERVICE RECOMMENDATION METHOD

(71) Applicant: HITACHI, LTD., Tokyo (JP)

(72) Inventors: Noriyuki Haga, Tokyo (JP); Toshiyuki Nakamura, Tokyo (JP); Iwao Tanuma, Tokyo (JP); Ippei Hinoki, Tokyo (JP); Chie Nemoto, Tokyo (JP); Kentaro Asai, Tokyo (JP)

(73) Assignee: HITACHI, LTD., Tokyo (JP)

(21) Appl. No.: 18/699,743

(22) PCT Filed: Oct. 21, 2022
(86) PCT No.: PCT/JP2022/039326

§ 371 Date: Apr. 9, 2024

(30) Foreign Application Priority Data
Oct. 28, 2021 (JP) 2021-176487

(51) Int. Cl. G06Q 10/0637

(52) U.S. Cl. CPC G06Q 10/06375

(57) ABSTRACT

A computer system manages service management information for managing a correspondence relation between a magnitude of maturity representing a degree of promotion of digital transformation in a business operation and a service useful for the promotion of the digital transformation in the business operation, acquires, from a business system operated by a first business operator, operating data including information on an operation of the business system, estimates the maturity of the business system of the first business operator based on the operating data, identifies a service with reference to the service management information based on the maturity, the service being recommended to be introduced to the first business operator, and presents information on the identified service.

### CROSS-REFERENCE TO RELATED APPLICATIONS

This application is based on the priority of Japanese Patent Application No. 2021-176487 filed on Oct. 28, 2021, the entire contents of which are incorporated herein by reference.

### TECHNICAL FIELD

The present invention relates to a service recommendation technique useful for DX promotion.

### BACKGROUND ART

In recent years, DX promotion in companies has been actively made. NPL 1 describes that although “In every industry, a new participant who develops an unprecedented business model by using a new digital technique is emerging, and a game change is occurring. Under such circumstances, each company is required to speedily advance digital transformation (DX) in order to maintain and enhance competitiveness.” (see page 1 of NPL 1), “The current status in many Japanese companies is that although managers are aware of a necessity of the DX and have carried out activities such as establishing a digital department, actual business transformation has not been implemented.” (see page 1 of NPL 1), and “Promotion of DX also requires transformation in a traditional way of working and corporate culture, and in order to overcome the problems described above and implement the DX, it is essential that related parties, such as executives, business departments, DX departments, and IT departments, share awareness of the current status and problems and take action.” (see page 2 of NPL 1), and describes that “The DX promotion index” is “an index aiming to provide an opportunity to notice that managers and other internal stakeholders share awareness of the current status of activities of their company, a gap between an ideal state and the current status, and countermeasures to achieve the ideal state and take the necessary actions in order to promote the DX.” (see page 2 of NPL 1), and “The index is based on self-diagnosis, and it is assumed that the executives, business departments, DX departments, IT departments, and the like will discuss and respond to each index item.” (see page 2 of NPL 1).

In addition, PTL 1 discloses that “Provided is a financial product recommendation program that causes a computer to execute processing of estimating a future account balance based on an account balance and a past deposit and withdrawal history, and transmitting different financial product information depending on whether the estimated account balance is above or below a past trend of the account balance.”.

### CITATION LIST

### Patent Literature

PTL 1: JP2018-163596A

### Non Patent Literature

NPL 1: “DX promotion index” and its guidance, Authored by Ministry of Economy, Trade and Industry, July 2019, [searched on Oct. 15, 2021], Internet (https://www.meti.go.jp/press/2019/07/20190731003/20190731 003-1.pdf)

### SUMMARY OF INVENTION

### Technical Problem

NPL 1 describes the “DX promotion index” indicating a degree of DX promotion in a company. However, the DX promotion index is based on self-diagnosis of the company, and thus it is difficult to objectively grasp the degree of DX promotion of the company. Therefore, even if the “DX promotion index” is utilized, there is a risk that an initiative, a tool, a service, or the like necessary for promotion of the DX in the company depending on the way of performing self-diagnosis cannot be appropriately selected. In addition, a provider that provides IT tools, services, and the like for DX promotion cannot accurately grasp the degree of DX promotion performed by a customer, and it is difficult to propose products and services thereof optimal for the customer.

### Solution to Problem

A representative example of the invention disclosed in this application is as follows. That is, a computer system includes at least one computer including a processor, a storage device connected to the processor, and a network interface connected to the processor and manages service management information for managing a correspondence relation between a magnitude of maturity representing a degree of promotion of digital transformation in a business operation and a service useful for the promotion of the digital transformation in the business operation. The at least one computer acquires, from a business system operated by a first business operator, operating data including information n operation of the business system, estimates the maturity of the business system of the first business operator based on the operating data, identifies a service with reference to the service management information based on the maturity, the service being recommended to be introduced to the first business operator, and presents information on the identified service.

### Advantageous Effects of Invention

According to the invention, it is possible to objectively grasp a degree of DX promotion in a company and appropriately select an initiative, a tool, a service, or the like necessary for DX promotion in a company. The problems, configurations, and effects other than those described above will become apparent in the following description of embodiments.

### BRIEF DESCRIPTION OF DRAWINGS

FIG. 1 is a diagram showing a configuration example of a system according to Embodiment 1.

FIG. 2 is a diagram showing a configuration example of a computer constituting a platform according to Embodiment 1.

FIG. 3 is a diagram showing an example of operating data management information according to Embodiment 1.

FIG. 4A is a diagram showing an example of service management information according to Embodiment 1.

FIG. 4B is a diagram showing an example of service management information according to Embodiment 1.

FIG. 5 is a diagram showing an example of maturity upper limit information according to Embodiment 1.

FIG. 6 is a flowchart showing an outline of processing executed by the platform according to Embodiment 1.

FIG. 7 is a flowchart showing an example of operating data acquisition processing executed by the platform according to Embodiment 1.

FIG. 8 is a flowchart showing an example of maturity estimation processing performed by the platform according to Embodiment 1.

FIG. 9 shows an example of service recommendation processing executed by the platform according to Embodiment 1.

FIG. 10 shows an example of service recommendation processing executed by the platform according to Embodiment 1.

### DESCRIPTION OF EMBODIMENTS

Hereinafter, embodiments of the invention will be described with reference to the drawings. However, the invention is not to be construed as being limited to the description of the following embodiments. It will be easily understood by those skilled in the art that the specific configuration can be changed without departing from the spirit or scope of the invention.

In the configurations of the invention described below, the same or similar configurations or functions are denoted by the same reference numerals, and a redundant description will be omitted.

Notations “first”, “second”, “third”, and the like in the present specification and the like are provided to identify components, and do not necessarily limit the number or the order of those components.

### Embodiment 1

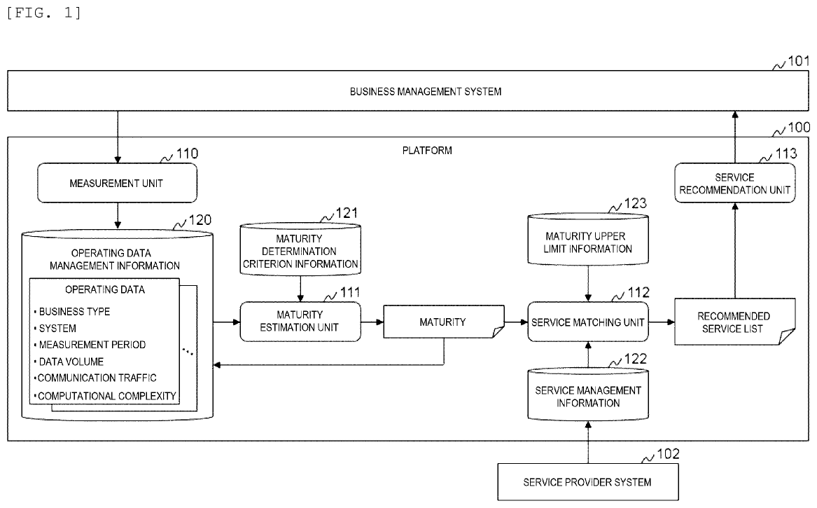

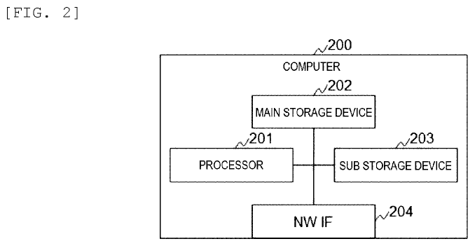

FIG. 1 is a diagram showing a configuration example of a system according to Embodiment 1. FIG. 2 is a diagram showing a configuration example of a computer constituting a platform according to Embodiment 1.

The system includes a platform 100, a business management system 101, and a service provider system 102. The platform 100, the business management system 101, and the service provider system 102 are connected to one another via a network such as a local area network (LAN). A connection method of the network may be wired or wireless.

The business management system 101 is a system operated by a company that performs business operation. On the business management system 101, one or more business systems operate for each operations type.

The service provider system 102 is a system operated by a service provider. The service provider system 102 registers information on a service to be provided in the platform 100. The information is stored in service management information 122.

The platform 100 estimates a degree of promotion (maturity) of DX of a company and recommends a service provided by the service provider according to the maturity. The platform 100 is implemented by a computer 200 as shown in FIG. 2. The platform 100 may include a storage system, a network switch, and the like.

The computer 200 includes a processor 201, a main storage device 202, a sub storage device 203, and a network interface 204. The computer 200 may include an input device and an output device.

The processor 201 executes a program stored in the main storage device 202. The processor 201 executes processing according to a program to operate as a functional unit (module) that implements a specific function. In the following description, when processing is described with a functional unit as a subject, it indicates that the processor 201 executes a program for implementing the functional unit. The main storage device 202 is a memory or the like, and stores a program executed by the processor 201 and data used by the program. The sub storage device 203 is a hard disk drive (HDD), a solid state drive (SSD), or the like, and permanently stores data. The program and data stored in the main storage device 202 may be stored in the sub storage device 203. In this case, the processor 201 reads the program and the data from the sub storage device 203 and loads the program and the data into the main storage device 202. The network interface 204 communicates with other devices via a network.

The platform 100 includes, as a functional configuration, a measurement unit 110, a maturity estimation unit 111, a service matching unit 112, and a service recommendation unit 113. The platform 100 manages operating data management information 120, maturity determination criterion information 121, service management information 122, and maturity upper limit information 123.

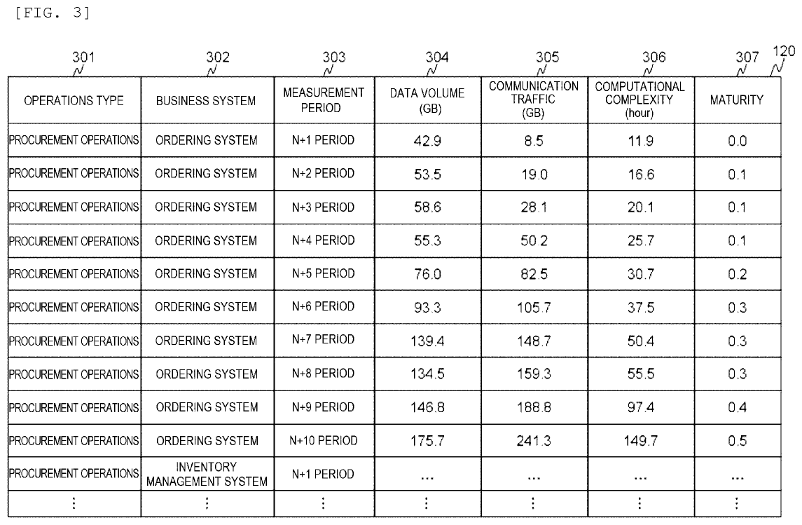

The operating data management information 120 is information for managing operating data related to an operating state of the business system. The operating data includes identification information, a measurement period, a data volume, a communication traffic, a computational complexity of the business system, and the like. Details of the operating data management information 120 will be described with reference to FIG. 3.

The maturity determination criterion information 121 is information in which a criterion for determining maturity indicating the degree of promotion of the DX in the business system is defined. The maturity determination criterion information 121 stores, for example, the following mathematical expression.

$$\begin{matrix}[ Formula 1 ] & \\ U = F ( p , q , r , v ) = \frac{a p + b q + c r}{v} & ( 1 )\end{matrix}$$

Here, U represents maturity, p represents a data volume, q represents a communication traffic, r represents a computational complexity, and v represents a scale of business operation. The scale of business operation represents a production scale (production quantity) in the case of, for example, a manufacturing industry. The sales or the like may be treated as the scale of business operation. a, b, and c represent coefficients.

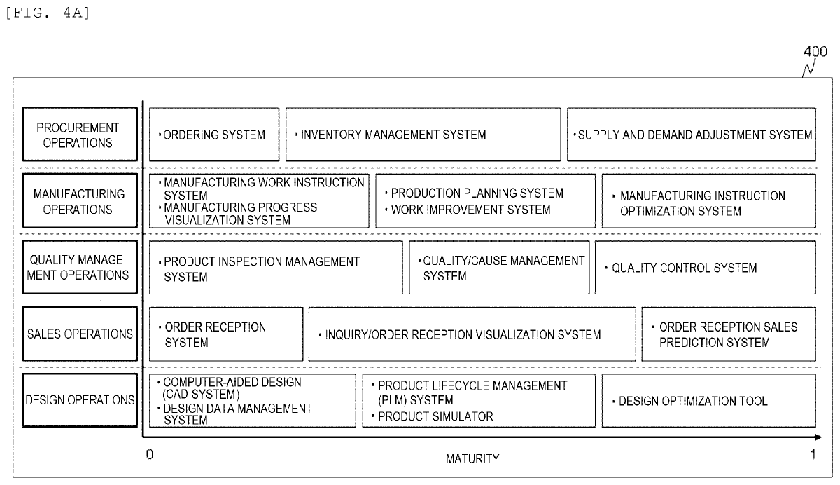

The service management information 122 is information for managing services. Details of the service management information 122 will be described with reference to FIGS. 4A and 4B.

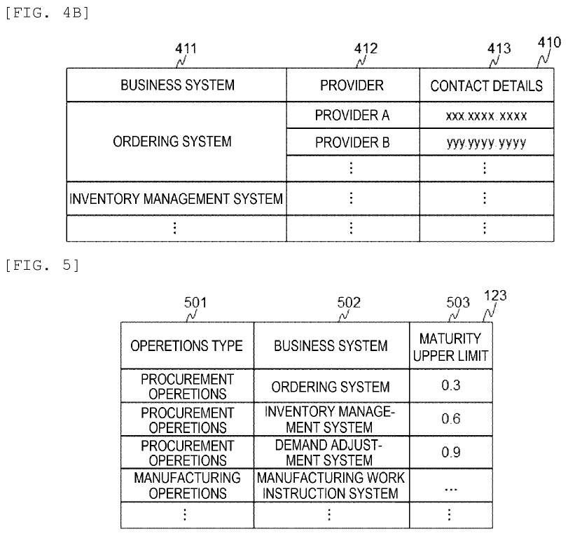

The maturity upper limit information 123 is information for managing an upper limit of the maturity of a business system of a company. Details of the maturity upper limit information 123 will be described with reference to FIG. 5.

The measurement unit 110 measures a value related to an operating state of each business system operating on the business management system 101, and stores operating data including the measurement result in the operating data management information 120. In the present embodiment, the volume of data managed by the business system, the communication traffic of the business system, and the computational complexity of the business system are measured. Here, the communication traffic is the volume of data transmitted and received by the business system through communication with the outside, and the computational complexity is a cumulative value of operating time of the processor of the computer constituting the business system. The value to be measured is an example, and the invention is not limited thereto.

The maturity estimation unit 111 estimates the maturity of the business system using the maturity determination criterion information 121 and the operating data. The maturity estimation unit 111 registers the maturity in association with the operating data.

The service matching unit 112 identifies, based on the maturity of the business system and the service management information 122, a service to be recommended to the company. The service matching unit 112 generates a recommended service list including information on the identified service. The service matching unit 112 identifies the upper limit of the maturity from time-series data of the maturity of the business system and registers an upper limit of the maturity in the maturity upper limit information 123.

The service recommendation unit 113 recommends the service to the business management system 101 based on the recommended service list. For example, the service recommendation unit 113 presents a screen for displaying the recommended service list to the business management system 101.

For each functional unit of the platform 100, a plurality of functional units may be integrated into one functional unit, or one functional unit may be divided into a plurality of functional units for each function.

FIG. 3 is a diagram showing an example of the operating data management information 120 according to Embodiment 1.

The operating data management information 120 stores entries including an operations type 301, a business system 302, a measurement period 303, a data volume 304, a communication traffic 305, a computational complexity 306, and a maturity 307. One entry is present for a combination of the operating data and the maturity. In the present embodiment, it is assumed that one piece of operating data management information 120 is present for one company (the business management system 101). The fields included in the entries are not limited to those described above.

The operations type 301 is a field for storing information indicating a type of operations in the business operation. The business system 302 is a field for storing identification information on the business system.

The measurement period 303 is a field for storing information indicating a period in which a measurement is performed. In the present embodiment, the measurement is performed every any period such as a quarter or one month. The data volume 304 is a field for storing a volume of data managed by a business system. The communication traffic 305 is a field for storing the communication traffic of a business system. The computational complexity 306 is a field for storing a computational complexity of a business system. The maturity 307 is a field for storing maturity of a business system. The operating data may include at least one of a data volume, a communication traffic, and a computational complexity.

FIGS. 4A and 4B are diagrams showing an example of the service management information 122 according to Embodiment 1.

The service management information 122 includes matching information 400 and provider information 410. The matching information 400 is information for identifying a business system to be improved in promotion of DX of the business system based on a magnitude of the maturity. The provider information 410 is information for managing a service provider.

As shown in FIG. 4A, the matching information 400 stores information indicating a correspondence relation between the magnitude of the maturity and the business system to be improved for each operations type. A lateral length of a rectangle representing a business system represents a range of the magnitude of the maturity.

As shown in FIG. 4B, the provider information 410 stores entries including a business system 411, a provider 412, and a contact detail 413. One entry is present for one business system. In addition, rows of one or more service providers are included for one business system. The fields included in the entries are not limited to those described above.

The business system 411 is a field for storing identification information on a business system. The provider 412 is a field for storing identification information on a service provider that provides a service useful for promotion of DX of a business system. For example, a name of a service provider is stored. The contact detail 413 is a field for storing contact details of a service provider. For example, a URL, a telephone number, or the like is stored.

The matching information 400 and the provider information 410 may be integrated into the service management information 122.

FIG. 5 is a diagram showing an example of the maturity upper limit information 123 according to Embodiment 1.

The maturity upper limit information 123 stores entries including an operations type 501, a business system 502, and a maturity upper limit 503. One entry is present for a combination of an operations type and a business system. In the present embodiment, it is assumed that one piece of maturity upper limit information 123 is present for one company (the business management system 101). The fields included in the entries are not limited to those described above.

The operations type 501 is a field for storing information indicating a type of v in the business operation. The business system 502 is a field for storing identification information on a business system. The maturity upper limit 503 is a field for storing an upper limit of maturity.

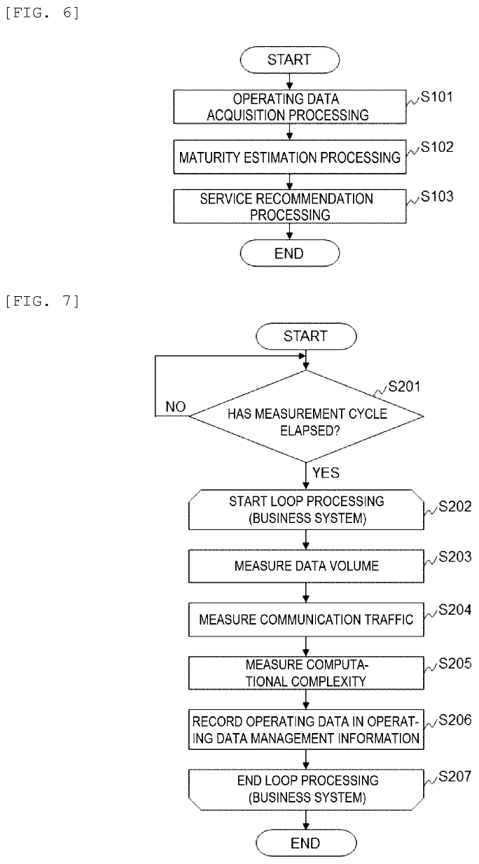

FIG. 6 is a flowchart showing an outline of processing executed by the platform 100 according to Embodiment 1.

First, the platform 100 executes operating data acquisition processing (step S101). Details of the operating data acquisition processing will be described later with reference to FIG. 7.

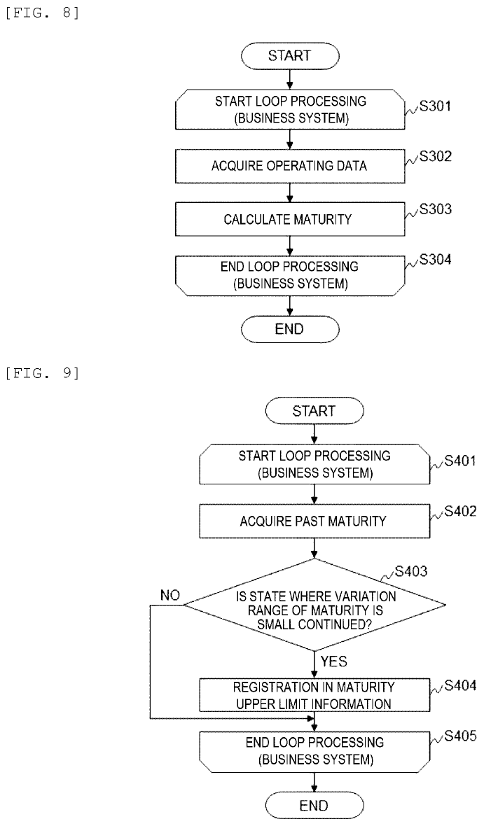

Next, the platform 100 executes maturity estimation processing using the operating data (step S102). Details of the maturity estimation processing will be described with reference to FIG. 8.

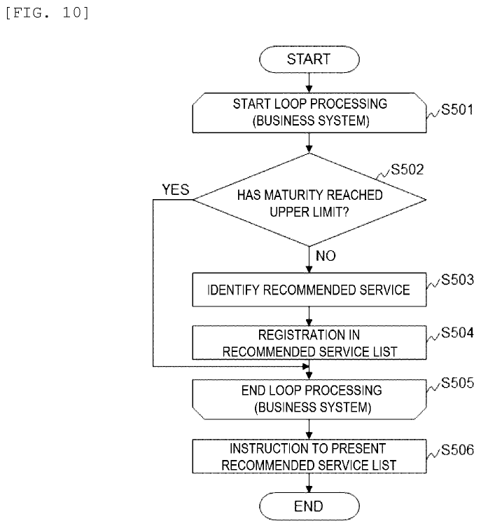

Next, the platform 100 executes service recommendation processing using the maturity (step S103), and then ends the processing. Details of the service recommendation processing will be described with reference to FIGS. 9 and 10.

FIG. 7 is a flowchart showing an example of the operating data acquisition processing executed by the platform 100 according to Embodiment 1.

The measurement unit 110 executes processing described below for one business management system 101.

First, the measurement unit 110 determines whether a measurement cycle has elapsed (step S201). The measurement cycle can be set to any value. A different measurement cycle may be set for each business management system 101.

When the measurement cycle has not elapsed, the measurement unit 110 returns to step S201 after a certain period has elapsed.

When the measurement cycle has elapsed, the measurement unit 110 starts loop processing of a business system (step S202). Specifically, the measurement unit 110 selects a target business system. It is assumed that information on a business system operating on the business management system 101 is registered in the platform 100 in advance.

The measurement unit 110 measures a data volume managed by the business system (step S203). For example, the measurement unit 110 accesses a database managed by the business system and measures the data volume. The measurement unit 110 may acquire the data volume by inquiring the business system about the data volume.

The measurement unit 110 measures a communication traffic of the business system until the measurement cycle elapses (step S204). For example, the measurement unit 110 acquires a communication history from the business system and calculates a total value of the data volumes transmitted and received in the communication based on the communication history. Note that a method may be used in which an agent for measuring the communication traffic is set in advance in the business system and information is acquired from the agent.

The measurement unit 110 measures the computational complexity of the business system until the measurement cycle elapses (step S205). For example, the measurement unit 110 acquires a history related to operating time of a processor from the business system and calculates a total value of the operating time of the processor based on the history. Note that a method may be used in which an agent for measuring the operating time of the processor may be set in the business system in advance, and the information may be acquired from the agent.

The measurement unit 110 records the operating data in the operating data management information 120 (step S206). Specifically, the measurement unit 110 adds an entry to the operating data management information 120, and sets identification information on the operations type and identification information on the business system in the operations type 301 and the business system 302 of the added entry, respectively. The measurement unit 110 sets information on the period in which measurement is performed in the measurement period 303 of the added entry. The measurement unit 110 sets the measured data volume, communication traffic, and computational complexity in the data volume 304, the communication traffic 305, and the computational complexity 306 of the added entry, respectively.

The measurement unit 110 determines whether the processing is completed for all the business systems (step S207).

When the processing is not completed for all the business systems, the measurement unit 110 returns to step S202 and selects a new business system.

When the processing is completed for all the business systems, the measurement unit 110 ends the operating data acquisition processing.

FIG. 8 is a flowchart showing an example of the maturity estimation processing performed by the platform 100 according to Embodiment 1.

The maturity estimation unit 111 executes processing described below for one business management system 101.

The maturity estimation unit 111 starts loop processing of a business system (step S301). Specifically, the maturity estimation unit 111 selects a target business system.

The maturity estimation unit 111 acquires operating data of the business system (step S302). Here, it is assumed that the latest operating data is acquired.

The maturity estimation unit 111 calculates the maturity based on the data volume, the communication traffic, and the computational complexity included in the operating data of the business system (step S303). For example, the maturity is calculated using Formula (1). The maturity estimation unit 111 sets the calculated maturity in the maturity 307 of an entry corresponding to the operating data of the operating data management information 120.

The maturity estimation unit 111 determines whether the processing is completed for all the business systems (step S304).

When the processing is not completed for all the business systems, the maturity estimation unit 111 returns to step S301 and selects a new business system.

When the processing is completed for all the business systems, the maturity estimation unit 111 ends the maturity estimation processing.

FIGS. 9 and 10 show an example of the service recommendation processing executed by the platform 100 according to Embodiment 1.

The service matching unit 112 executes maturity upper limit determination processing shown in FIG. 9 for one business management system 101.

The service matching unit 112 starts loop processing of a business system (step S401). Specifically, the service matching unit 112 selects a target business system.

The service matching unit 112 acquires the past maturity of the business system with reference to the operating data management information 120 (step S402). For example, the maturity in the period from now to one year ago is calculated.

The service matching unit 112 determines whether a state in which a variation range of the maturity index is small is continued for a certain period (for example, three months or longer) (step S403).

When the state in which the variation range of the maturity is small is not continued for a certain period, the service matching unit 112 proceeds to step S405.

When the state in which the variation range of the maturity is small is continued for a certain period, the service matching unit 112 identifies an upper limit of the maturity and registers the upper limit in the maturity upper limit information 123 (step S404). Thereafter, the service matching unit 112 proceeds to step S405. Specifically, the service matching unit 112 adds an entry to the maturity upper limit information 123, and sets identification information on the operations type and identification information on the business system in the operations type 501 and the business system 502 of the added entry, respectively. The service matching unit 112 sets the identified upper limit of the maturity in the maturity upper limit 503 of the added entry.

The service matching unit 112 determines whether the processing is completed for all the business systems (step S405).

When the processing is not completed for all the business systems, the service matching unit 112 returns to step S401 and selects a new business system.

When the processing is completed for all the business systems, the service matching unit 112 ends the maturity upper limit determination processing.

After the maturity upper limit determination processing is completed, the service matching unit 112 executes service matching processing shown in FIG. 10 for one business management system 101.

The service matching unit 112 starts loop processing of a business system (step S501). Specifically, the service matching unit 112 selects a target business system.

The service matching unit 112 determines whether the maturity of the business system reaches the upper limit with reference to the maturity upper limit information 123 (step S502). Specifically, the service matching unit 112 determines whether there is an entry in which identification information on the target operations type and the identification information on the business system are set in the operations type 501 and the business system 502, respectively. When the above-described entry is present, the service matching unit 112 determines that the maturity of the business system reaches the upper limit.

When the maturity of the business system reaches the upper limit, the service matching unit 112 proceeds to step S505. When the maturity of the business system reaches the upper limit, the service is controlled not to be recommended because further promotion of the DX is not necessary.

When the maturity of the business system does not reach the upper limit, the service matching unit 112 identifies the recommended service based on the latest maturity of the business system, the matching information 400, and the provider information 410 (step S503). Specifically, the following processing is executed.

(S503-1) The service matching unit 112 identifies a business system to be improved with reference to the matching information 400 based on the latest maturity of the business system.

(S503-2) The service matching unit 112 identifies a service provider with reference to the provider information 410 based on the identified business system. The processing in step S503 has been described above.

The service matching unit 112 registers the identified recommended service in the recommended service list (step S504). Thereafter, the service matching unit 112 proceeds to step S505. Specifically, the service matching unit 112 registers data including the business system type, the service provider, and the contact detail in the recommended service list. The maturity may be included in the data.

The service matching unit 112 determines whether the processing is completed for all the business systems (step S505).

When the processing is not completed for all the business systems, the service matching unit 112 returns to step S501 and selects a new business system.

When the processing is completed for all the business systems, the service matching unit 112 instructs the service recommendation unit 113 to present the recommended service list (step S506). Thereafter, the service matching unit 112 ends the service matching processing.

According to Embodiment 1, the platform 100 can quantitatively evaluate a promotion degree of the DX for each business system of a company and recommend a service for promoting the promotion of the DX. The service provider can obtain an opportunity to acquire a customer by registering information on a platform in advance. The company can grasp the business system to be improved and the service necessary for the improvement in the promotion of the DX.

The business management system 101 may include the function of the platform 100. Accordingly, the company can grasp the promotion degree of the DX of the company and grasp the service necessary for promoting the promotion of the DX.

The invention is not limited to the above-described embodiments, and includes various modifications. For example, the above-described embodiments are described in detail in order to describe the invention in an easy-to-understand manner, and the invention is not necessarily limited to those including all the described configurations. A part of a configuration in each embodiment may be added to, deleted from, or replaced with another configuration.

A part or all of configurations, functions, processing units, processing methods, and the like described above may be implemented by hardware by, for example, designing with an integrated circuit. The invention can also be implemented by a program code of software for implementing the functions in the embodiments. In this case, a storage medium recording the program code is provided to a computer, and a processor provided in the computer reads the program code stored in the storage medium. In this case, the program code read from the storage medium implements the functions of the embodiments described above by itself, and the program code itself and the storage medium storing the program code constitute the invention. Examples of the storage medium for supplying such a program code include a flexible disk, a CD-ROM, a DVD-ROM, a hard disk, a solid state drive (SSD), an optical disk, a magneto-optical disk, a CD-R, a magnetic tape, a nonvolatile memory card, and a ROM.

Further, the program code for implementing the functions described in the present embodiment can be implemented in a wide range of programs or script languages such as assembler, C/C++, Perl, Shell, PHP, Python, and Java.

Further, the program code of the software for implementing the functions in the embodiments may be distributed via a network to be stored in a storage unit such as a hard disk or a memory of a computer or a storage medium such as a CD-RW or a CD-R, and a processor provided in the computer may read and execute the program code stored in the storage unit or the storage medium.

Control lines and information lines considered to be necessary for description are illustrated in the embodiments described above, and not all control lines and information lines in a product are necessarily illustrated. All the components may be connected to each other.

1. A computer system comprising:
at least one computer including a processor, a storage device connected to the processor, and a network interface connected to the processor, wherein
the computer system manages service management information for managing a correspondence relation between a magnitude of maturity representing a degree of promotion of digital transformation in a business operation and a service useful for the promotion of the digital transformation in the business operation, and
the at least one computer
acquires, from a business system operated by a first business operator, operating data including information on an operation of the business system,
estimates the maturity of the business system of the first business operator based on the operating data,
identifies a service with reference to the service management information based on the maturity, the service being recommended to be introduced to the first business operator, and
presents information on the identified service.

2. The computer system according to claim 1, wherein
the first business operator operates a plurality of business systems, and
the at least one computer
estimates the maturity for each of the plurality of business systems of the first business operator, and
identifies a service recommended to be introduced to the first business operator for each of the plurality of business systems of the first business operator.

3. The computer system according to claim 1, wherein
the operating data includes at least one of a volume of data managed by the business system, a communication traffic of the business system, and a computational complexity of the business system.

4. The computer system according to claim 1, wherein
the operating data associated with the maturity is managed, and
the at least one computer
determines, using the maturity associated with each of a plurality of pieces of the operating data, whether the maturity of the business system of the first business operator reaches an upper limit, and
identifies a service with reference to the service management information based on the latest maturity when the maturity of the business system of the first business operator does not reach the upper limit, the service being recommended to be introduced to the first business operator.

5. A service recommendation method executed by a computer system, wherein
the computer system
includes at least one computer that includes a processor, a storage device connected to the processor, and a network interface connected to the processor, and
manages service management information for managing a correspondence relation between a magnitude of maturity representing a degree of promotion of digital transformation in a business operation and a service useful for the promotion of the digital transformation in the business operation,
the service recommendation method comprising:
a first step of acquiring, by the at least one computer from a business system operated by a first business operator, operating data including information on an operation of the business system;
a second step of estimating, by the at least one computer, the maturity of the business system of the first business operator based on the operating data;
a third step of identifying, by the at least one computer, a service with reference to the service management information based on the maturity, the service being recommended to be introduced to the first business operator; and
a fourth step of presenting, by the at least one computer, information on the identified service.

6. The service recommendation method according to claim 5, wherein
the first business operator operates a plurality of business systems,
the second step includes a step of estimating, by the at least one computer, the maturity for each of the plurality of business systems of the first business operator, and
the third step includes a step of identifying, by the at least one computer, a service recommended to be introduced to the first business operator for each of the plurality of business systems of the first business operator.

7. The service recommendation method according to claim 5, wherein
the operating data includes at least one of a volume of data managed by the business system, a communication traffic of the business system, and a computational complexity of the business system.

8. The service recommendation method according to claim 5, wherein
the computer system manages the operating data associated with the maturity, and
the third step includes:
a step of determining, using the maturity associated with each of a plurality of pieces of the operating data by the at least one computer, whether the maturity of the business system of the first business operator reaches an upper limit; and
a step of identifying, by the at least one computer, a service with reference to the service management information based on the latest maturity when the maturity of the business system of the first business operator does not reach the upper limit, the service being recommended to be introduced to the first business operator.
